(19) United States
(12) Patent Application Publication
(10) Pub. No.: US 2025/0164727 A1
(43) Pub. Date: May 22, 2025

(54) CONSOLIDATION TERMINALS

(71) Applicant: AFL Telecommunications LLC, Duncan, SC (US)

(72) Inventor: William Joseph Miller, Easley, SC (US)

(21) Appl. No.: 18/841,536

(22) PCT Filed: Feb. 28, 2023
(86) PCT No.: PCT/US2023/014027

§ 371 Date: Aug. 26, 2024

Related U.S. Application Data
(60) Provisional application No. 63/314,767, filed on Feb. 28, 2022.

(51) Int. Cl. G02B 6/44

(52) U.S. Cl. CPC G02B 6/44515; G02B 6/44528

(57) ABSTRACT

A consolidation terminal includes a body defining an interior, a stub cable port defined in the body, and a stub cable extending through the stub cable port, the stub cable including an optical fiber. The consolidation terminal further includes a splitter disposed in the interior, wherein the optical fiber is connected as an input to the splitter. The consolidation terminal includes a plurality of connector ports defined in the body, at least one single fiber connector disposed within at least one of the plurality of connector ports, the at least one single fiber connector connected to an output optical fiber from the splitter, and at least one multi-fiber connector disposed within at least one of the plurality of connector ports, the at least one multi-fiber connector connected to a plurality of output optical fibers from the splitter.

### CROSS-REFERENCE TO RELATED APPLICATIONS

The present application claims priority to U.S. Provisional Patent Application Ser. No. 63/314,767 filed on February 28. 2022, the disclosure of which is incorporated by reference herein in its entirety.

### FIELD

The present disclosure relates generally to fiber optic terminals, and more particularly to multiport fiber optic terminals which may be utilized with multifiber connectors.

### BACKGROUND

Most modern fiber to the home (FTTH) deployments utilize a PON (passive optical network) architecture which use optical splitting to lower the number of active laser devices needed at the central office before splitting to higher fiber counts to service multiple homes. A 1×32 splitter is the most common, but split ratios from 1×128 all the way to 1×2 can be used depending on the network. In more densely populated areas, splitters may be consolidated together in a cabinet, such as a cabinet placed at the front of a subdivision to split a lower number of feeder fibers from the central office to a higher number of fibers to feed multiple homes.

In rural FTTH deployments, splitters are placed deeper in the network due to the low density of homes along a route. This keeps the fiber counts needed to service these homes low with the jump up to higher fiber counts only performed when needed. Today, many rural FTTH customers are serviced with terminals that are sealed and have a hardened, sealed connector interface for the drop cables that run to individual homes. The terminal is factory “stubbed” with a predetermined length of cable with a fiber count determined by the number of ports on the terminal. Terminals can be anywhere as short as 25-50 feet where they are typically located at the same location as the splice closure, or several thousand feet long where they can run to other locations in the network. Using longer length tails to consolidate multiple terminals at one splice location offers a few advantages —1) it allows multiple terminals to be bunched together to utilize a single splitter, thus a single fiber from the central office and a single laser: 2) it lowers the number of splice points in the network. Each splice point is a potential failure point, and it requires splice labor to strip the cables, place into the closure, and splice. When multiple tails enter a consolidation point, each cable tail must be prepared and installed in the closure, which takes time due to the cable stripping process and routing inside the closure.

U.S. Pat. Nos. 7,444,056 and 7,120,347, both of which are incorporated by reference herein. are examples of prior art approaches.

Accordingly, consolidation terminals would be advantageous. Specifically, terminals which address one of more of the above-stated deficiencies would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a consolidation terminal is provided. The consolidation terminal includes a body defining an interior, a stub cable port defined in the body, and a stub cable extending through the stub cable port, the stub cable including an optical fiber. The consolidation terminal further includes a splitter disposed in the interior, wherein the optical fiber is connected as an input to the splitter. The consolidation terminal includes a plurality of connector ports defined in the body, at least one single fiber connector disposed within at least one of the plurality of connector ports, the at least one single fiber connector connected to an output optical fiber from the splitter, and at least one multi-fiber connector disposed within at least one of the plurality of connector ports, the at least one multi-fiber connector connected to a plurality of output optical fibers from the splitter.

In accordance with another embodiment, a fiber optic network is provided. The fiber optic network includes a consolidation terminal and a connection terminal. The consolidation terminal includes a body defining an interior, a stub cable port defined in the body, and a stub cable extending through the stub cable port, the stub cable including an optical fiber. The consolidation terminal further includes a splitter disposed in the interior, wherein the optical fiber is connected as an input to the splitter. The consolidation terminal further includes a plurality of connector ports defined in the body, at least one single fiber connector disposed within at least one of the plurality of connector ports, the at least one single fiber connector connected to an output optical fiber from the splitter, and at least one multi-fiber connector disposed within at least one of the plurality of connector ports, the at least one multi-fiber connector connected to a plurality of output optical fibers from the splitter. The connection terminal includes a body defining an interior, a stub cable port defined in the body, and a plurality of connector ports defined in the body. The connection terminal further includes a secondary stub cable extending through the stub cable port, the secondary stub cable including a plurality of optical fibers, wherein the secondary stub cable extends between a distal end exterior to the body and a proximal end interior to the body. The secondary stub cable includes a connector disposed at the distal end of the secondary stub cable and connected to the plurality of optical fibers of the secondary stub cable. The secondary stub cable includes a connector disposed within at least one of the plurality of connector ports, the at least one secondary connector connected to one of the plurality of optical fiber of the secondary stub cable. The connector disposed at the distal end of the secondary stub cable is connectable within a connector port of the consolidation terminal.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a schematic illustration of a known fiber optic communications network;

FIG. 2 is a schematic illustration of a fiber optic communications network in accordance with embodiments of the present disclosure;

FIG. 3 is a side perspective view of a communication terminal in accordance with embodiments of the present disclosure;

FIG. 4 is a side schematic interior view of a communication terminal in accordance with embodiments of the present disclosure;

FIG. 5 is a side perspective view of a consolidation terminal in accordance with embodiments of the present disclosure; and

FIG. 6 is a side schematic interior view of a consolidation terminal in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure moves the splitter from the splice closure into a multiport terminal. The multiport terminal will have a combination of single-fiber and multi-fiber hardened connector ports that is fed with a single-fiber cable input. The single fiber will be then split inside the multiport terminal in a ratio of, for example, anywhere from 1×2 up to 1×32, 1×128, etc. The splitter will have a quantity of connectors terminated to single-fiber ports on the terminal. If there are a remaining number of fibers, these fibers can be terminated to one or multiple multifiber hardened connector ports in a predetermined configuration. An example of this would be a terminal with a 1×32 splitter with 4 fibers terminated to single-fiber connector ports. The remaining 28 fibers from the 1×32 could be terminated to three 8 fiber multifiber connector ports and one 4 fiber multifiber connector port. The advantage of this method is eliminating the need for a splicing technician to strip and install 5 cables into the splice closure, and only install 1 cable into the closure. The splitter terminal would reside next to the splice closure, either underground, in a pedestal, on a cable strand, or on a utility pole. The multifiber connector ports would allow pre-terminated multiport terminals to connect to the splitter multiport terminal, rather than needing to strip each of the cables.

Another additional or alternative embodiment would be to have a single-fiber hardened connector port on the splice closure. The incoming distribution cable would then be installed into the closure, with a single fiber from that cable spliced to a pigtail the connects to the inside of that hardened connector port. The splitter multiport terminal could now be terminated with a hardened fiber optic connector and plugged into the connector port on the closure. This would now preclude the need for the splicing technician to strip any multiport terminal cable stubs at all.

The advantage of the above solution would be that the splicing technician can greatly reduce the number of cables he needs to install in the closure. This reduces labor expense and increases the speed of installation. Additionally, in the case of the fully terminated solution (connector port on the closure), installation of the multiport terminals does not require a splicing technician, so splicing operations could be performed separately of multiport installation, allowing more flexibility in project scheduling.

The present disclosure provides embodiments of a multi-port optical connection terminal which includes a plurality of connector ports that receive optical connectors for interconnecting one or more pre-connectorized fiber optic drop cables to a distribution cable at a branch point in a fiber optic communications network. The various embodiments of the present disclosure may be applied in an optical “fiber-to-the-X” (FTTX) network. As used herein, the term “drop cable” includes a fiber optic cable comprising a cable sheath or jacket surrounding at least one flexible transport tube containing one or more optical fibers. As used herein, the term “distribution cable” includes both a main feeder cable, a distribution cable and/or a branch cable, and may be any type of fiber optic cable having a fiber count greater than that of an associated drop cable. In one example, the distribution cable may comprise at least one, and preferably, a plurality of flexible buffer tubes. As used herein, the term “optical fiber” includes all types of single mode and multi-mode light waveguides, including one or more bare optical fibers, loose-tube optical fibers, tight-buffered optical fibers, ribbonized optical fibers and/or any other embodiments of a medium for transmitting light signals. Pre-connectorized drop cables may be readily connected to and disconnected from the multi-port optical connection terminal, such as to adaptors disposed within the connector ports thereof, thus eliminating the need for entering the multi-port terminal and splicing the optical fibers of the drop cables to optical fibers of a stub cable, as described herein.

The fiber optic drop cables may be optically connected, i.e. via the terminal, to optical fibers of a communications network, such as within a conventional outside plant closure, such as a local convergence cabinet (LCC), a pedestal, a network access point (NAP) closure, or a network interface device (NID). In some embodiments, the fiber optic drop cables extend from a NID located at a subscriber premises and are optically connected through the multi-port optical connection terminal to optical fibers of a stub cable at a branch point in the network. In turn, the optical fibers of the stub cable are optically connected to respective optical fibers of the communications network at a mid-span access location provided on a distribution cable. The mid-span access location may be provided at an aerial closure, a buried closure (also referred to as a below-grade closure) or an above ground telecommunications cabinet, terminal or pedestal. Likewise, the multi-port optical connection terminal may be provided at an aerial location, such as mounted to an aerial strand between telephone poles or mounted on a telephone pole, at a buried location, such as within a hand-hole or below grade vault, or at an above-ground location. such as within a cabinet. terminal, pedestal or above grade vault. Optical connection terminals in accordance with the present disclosure may thus facilitate the deployment of a FTTX communications network.

The multi-port optical connection terminal provides an accessible interconnection terminal for readily connecting, disconnecting or reconfiguring drop cables in the optical network, and in particular, for interconnecting drop cables with a distribution cable. As used herein, the term “interconnecting” describes the connection of a drop cable to a distribution cable through an optical connection terminal in accordance with the present disclosure. In other words, such terminals are quick-connect terminals for connecting drop cables to a distribution cable of an optical communications network at a location other than the actual mid-span access location provided on the distribution cable.

A stub cable of the multi-port optical connection terminal may be connected to the fiber optic distribution cable by any suitable means. The drop cables may be connected to the stub cable via a terminal, thus connecting the drop cables to the distribution cable. In accordance with the present disclosure, the stub cable may be securely connected to the optical connection terminal. In particular, a stub cable connector of the terminal may be utilized to connect a stub cable to the terminal.

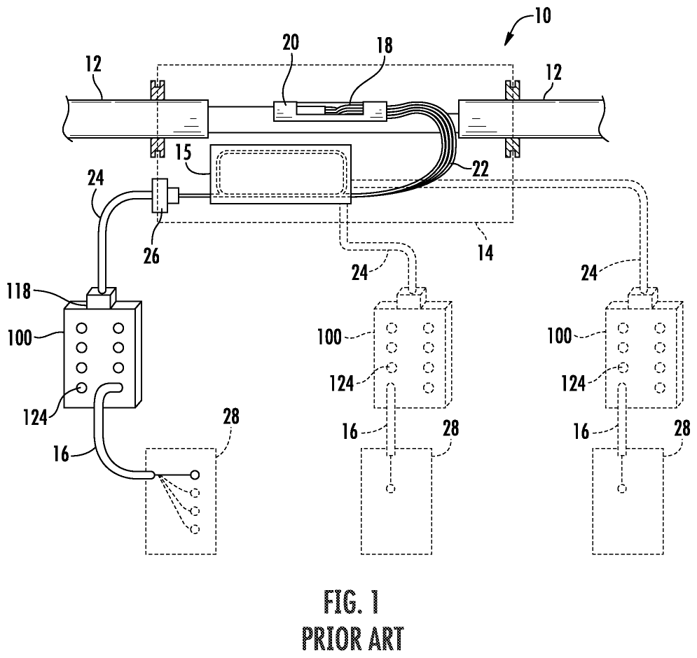

Referring now to FIG. 1, a portion of a known fiber optic communications network 10 which includes a fiber optic distribution cable 12 and at least one multi-port optical connection terminal 100 constructed in accordance with the present disclosure is shown. At least one (as shown), and preferably, a plurality of mid-span access locations are provided along the length of the distribution cable 12. The mid-span access location may be enclosed and protected from exposure to the environment by a conventional closure 14. In a preferred embodiment, the fiber optic communications network 10 comprises a fiber optic distribution cable 12 having a plurality of mid-span access locations at branch points spaced along the length of the distribution cable, each providing access to at least one, and preferably, a plurality of optical fibers 18 of the fiber optic network. Thus, the distribution cable 12 provides multiple locations for joining a stub cable 24 of at least one multi-port optical connection terminal 100 to the distribution cable 12 at each mid-span access location.

In the exemplary fiber optic network 10, pre-terminated optical fibers 18 of the distribution cable 12 provided at the mid-span access location are routed out of the distribution cable via an optical fiber transition element 20 and into corresponding hollow protective tubes 22. The optical fiber transition element 20 may include any structure that permits the pre-terminated optical fibers 18 to transition from the distribution cable 12 without excessive stress, strain or bending. The protective tubes 22 containing optical fibers 18 are routed into one or more splice trays 15, and the ends of the optical fibers 18 are spliced to respective optical fibers of a stub cable 24 extending from a multi-port optical connection terminal 100. The optical fibers of the stub cable 24 may enter the closure 14 through a suitable cable port 26 provided through an exterior wall, for example an end wall, of the closure 14. The stub cable 24 includes at least one, and preferably a plurality of optical fibers disposed within a protective cable sheath. The stub cable 24 may, for example, be any known fiber optic cable comprising at least one optical fiber and having a fiber count equal to or greater than that of a drop cable 16 to be connected to the multi-port optical connection terminal 100 and equal to or less than that of the distribution cable 12. The stub cable 24 may include a tubular body, such as, but not limited to, a buffer tube, a monotube or a tube formed from a water-swellable tape. In preferred embodiments, the stub cable 24 is flexible, easy to route and has no preferential bend.

The stub cable 24 extends from the closure 14 into the multi-port optical connection terminal 100 through a stub cable port 118 defined in the body 140 and provided through an exterior wall of the multi-port terminal. The optical fibers of the stub cable 24 within the multi-port optical connection terminal 100 may be pre-connectorized, and the optical connectors are each inserted into a connector adapter seated in one of the connector ports 124 provided through an exterior wall of the terminal. One or more pre-connectorized drop cables 16 are then interconnected with the connectorized optical fibers of the stub cable 24 by inserting the pre-connectorized ends of the drop cables 16 into the adapters seated in the connector ports 124 from the exterior of the multi-port optical connection terminal 100. A stub cable port 118 of the multi-port optical connection terminal 100 receives the stub cable 24 therethrough via a stub cable connector as discussed herein, and the connector adapters disposed in the connector ports 124 receive the pre-connectorized optical fibers of the stub cable 24 and the connectorized ends of the drop cables 16. The drop cables 16 include at least one single mode or multimode optical fiber of any type optically connected to a single fiber or multi-fiber optical connector in a conventional manner. The other ends of the drop cables 16 are optically connected to respective optical fibers of the communications network within an outside plant connection terminal 28 at a delivery point, such as an outside plant network access point (NAP) closure, local convergence cabinet (LCC), terminal, pedestal or network interface device (NID). As shown, one or more stub cables 24 extends from the closure 14 to a multi-port optical connection terminal 100 positioned at a distance from the mid-span access location, such as a telephone pole, hand-hole, vault or pedestal (not shown) in the fiber optic network 10. Each drop cable 16 extends from a multi-port optical connection terminal 100 to an outside plant connection terminal 28 located at a delivery point such as a subscriber premises.

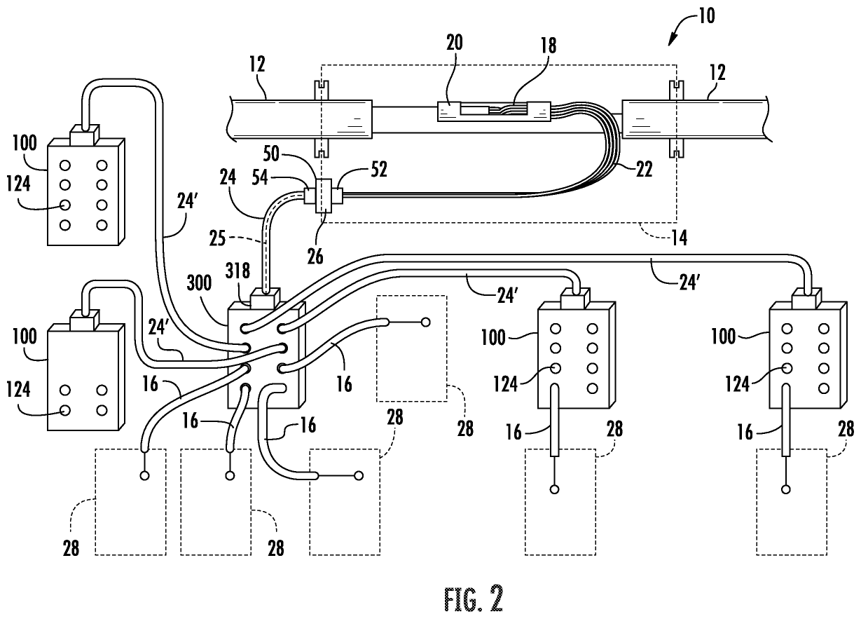

Referring now to FIG. 2, a portion of a known fiber optic communications network 10 which includes a fiber optic distribution cable 12, at least one consolidation terminal 300, and at least one multi-port optical connection terminal 100 constructed in accordance with the present disclosure is shown. At least one (as shown), and preferably, a plurality of mid-span access locations are provided along the length of the distribution cable 12. The mid-span access location may be enclosed and protected from exposure to the environment by a conventional closure 14. In a preferred embodiment, the fiber optic communications network 10 comprises a fiber optic distribution cable 12 having a plurality of mid-span access locations at branch points spaced along the length of the distribution cable, each providing access to at least one, and preferably, a plurality of optical fibers 18 of the fiber optic network. Thus, the distribution cable 12 provides multiple locations for joining a stub cable 24 of at least one consolidation terminal 300 and/or one multi-port optical connection terminal 100 to the distribution cable 12 at each mid-span access location.

In the exemplary fiber optic network 10, pre-terminated optical fibers 18 of the distribution cable 12 provided at the mid-span access location are routed out of the distribution cable via an optical fiber transition element 20 and into corresponding hollow protective tubes 22. The optical fiber transition element 20 may include any structure that permits the pre-terminated optical fibers 18 to transition from the distribution cable 12 without excessive stress, strain or bending.

In some embodiments (as illustrated in FIG. 1). the protective tubes 22 containing optical fibers 18 are routed into one or more splice trays 15, and the ends of the optical fibers 18 are spliced to respective optical fibers of a stub cable 24 extending from a multi-port optical connection terminal 100. The optical fibers of the stub cable 24 may enter the closure 14 through a suitable cable port 26 provided through an exterior wall, for example an end wall, of the closure 14.

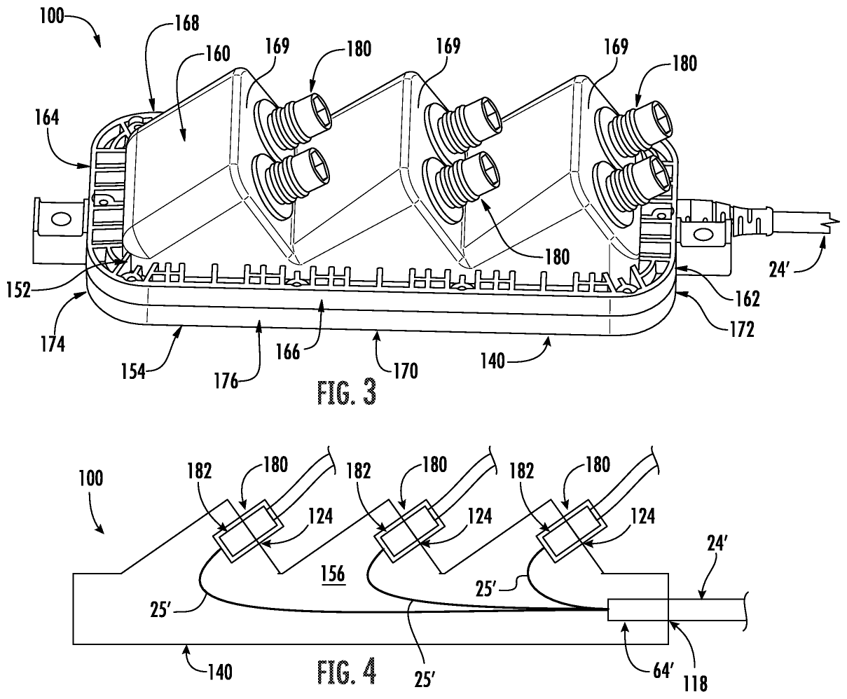

In other embodiments, as illustrated in FIG. 2, closure 14 may advantageously include an adapter 50 which facilitates a connection between the optical fiber(s) 25 of the stub cable 24 and the optical fiber(s) 18 of the distribution cable 12. For example, rather than (or in addition to) including splice trays 15, the optical fiber(s) 18 may be connectorized, and the connector(s) 52 that are connected to the ends of the optical fiber(s) 18 may be inserted into and thus disposed within the adapter 50, such as on an interior side of the adapter 50 interior to the closure 14. Further, the stub cable 24 may extend between a distal end 62 and a proximal end 64 (see FIG. 4). The distal end 62 may be exterior to the body of the consolidation terminal 300 or connection terminal 100, while the proximal end 64 is interior to the body of the consolidation terminal 300 or connection terminal 100. The stub cable 24 may further include a connector 54 disposed at the distal end 62 and connected to the optical fiber(s) 25 of the stub cable 24. The connector(s) 54 may be inserted into and thus disposed within the adapter 50, such as on an exterior side of the adapter 50 exterior to the closure 14. Accordingly and advantageously, splicing of the stub cable 24 within the closure 14 may not be required.

The stub cable 24 in these embodiments may advantageously include only a single optical fiber 25 or, alternatively, may include a plurality of optical fibers 25. The optical fibers may be disposed within a protective cable sheath. Advantageously, in these embodiments, the stub cable 24 need not have a fiber count equal to or greater than that of a drop cable 16 to be connected to the multi-port optical connection terminal 100 (as discussed above with respect to FIG. 1). The stub cable 24 may include a tubular body, such as, but not limited to, a buffer tube, a monotube or a tube formed from a water-swellable tape. In preferred embodiments, the stub cable 24 is flexible, easy to route and has no preferential bend.

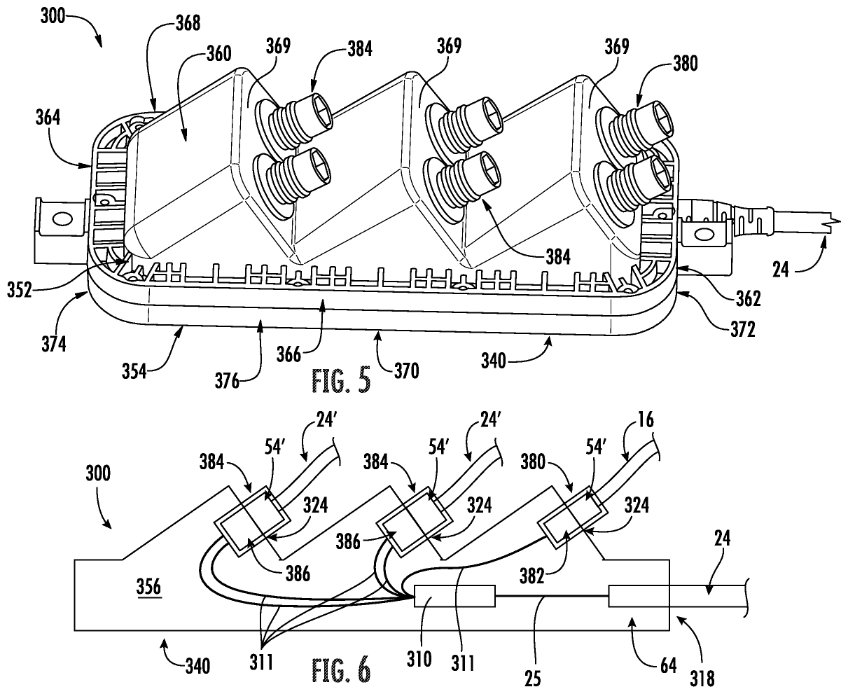

The stub cable 24 extends from the closure 14 into the consolidation terminal 300 through a stub cable port 318 defined in the body 340 and provided through an exterior wall of the consolidation terminal 300. The optical fiber(s) 25 of the stub cable 24 within the consolidation terminal 300 may advantageously be connected, such as directly connected as an input(s), to one or more optical splitter(s) 310 (see FIG. 6) disposed within an interior 356 of a body 340 of the consolidation terminal 300.

Any suitable splitter 310 may be utilized in a consolidation terminal 300 in accordance with the present disclosure. For example, the splitter 310 may be up to or at least a 1×2, 1×4, 1×8, 1×16, 1×32, 1×64 or 1×128 splitter. As is generally understood, a splitter 310 splits the optical signal from an input optical fiber into multiple output optical signals. Such output optical signals may be transmitted from the splitter 310 via a plurality of output optical fibers 311 which are connected, such as directly connected as outputs, to the one or more optical splitter(s) 310 within the interior 304.

A plurality of connector ports 324 may be provided defined in the body 302 and provided through one or more exterior walls of the consolidation terminal 300. The output optical fiber 311 may be advantageously be connected to connectors disposed within the connector ports 324. For example, the connectors may be disposed within adaptors 380, 384 which are disposed within the connector ports 324, such as on the interior side of such adaptors 380. At least one connector, such as in some embodiments a plurality of connectors, may be single fiber connectors 382. Each single fiber connector 382 may be connected to a single one of the plurality of output optical fibers 311. Further, at least one connector, such as in some embodiments a plurality of connectors, may be multi-fiber connectors 386. Each mult-fiber connector 386 may be connected to a plurality of output optical fibers 311. Further, in exemplary each single fiber connector 382 may be disposed within a single fiber adapter 380 which is disposed in a connector port 324, and each multi-fiber connector 386 may be disposed within a multi-fiber adapter 384 which is disposed in a connector port 324.

One or more pre-connectorized drop cables 16 may then interconnected with select output optical fibers 311, specifically the output optical fibers 311 connected to single fiber connectors 382 and/or output optical fibers 311 connected to multi-fiber connectors 386. Such connection is made by inserting the pre- connectorized ends of the drop cables 16 (e.g the connectors thereof) into the adapters 380, 384 seated in the connector ports 324 from the exterior of the consolidation terminal 300. The drop cables 16 include at least one single mode or multimode optical fiber of any type optically connected to a single fiber or multi-fiber optical connector in a conventional manner. The other ends of the drop cables 16 are optically connected to respective optical fibers of the communications network within an outside plant connection terminal 28 at a delivery point, such as an outside plant network access point (NAP) closure, local convergence cabinet (LCC), terminal, pedestal or network interface device (NID). As shown, one or more stub cables 24 extends from the closure 14 to a consolidation terminal 300 positioned at a distance from the mid-span access location, such as a telephone pole, hand-hole, vault or pedestal (not shown) in the fiber optic network 10. Each drop cable 16 extends from the consolidation terminal 300 to an outside plant connection terminal 28 located at a delivery point such as a subscriber premises.

Further, and advantageously, one or more pre-connectorized secondary stub cables 24′ may be interconnected with select output optical fibers 311, specifically the output optical fibers 311 connected to multi-fiber connectors 386. Such connection is made by inserting the pre-connectorized ends of the secondary stub cables 24′, such as connectors 54′ of the secondary stub cables 24′, into the adapters 384 seated in the connector ports 324 from the exterior of the consolidation terminal 300. The secondary stub cables 24′ in these embodiments may include a plurality of optical fibers 25′ and the connectors 54′ may be multi-fiber connectors. The stub cable 24′ may extend between a distal end 62′ and a proximal end 64 (see FIG. 4). The distal end 62′ may be exterior to the body of the connection terminal 100, while the proximal end 64 is interior to the body of the connection terminal 100. as discussed herein. The connector 54′ may be disposed at the distal end 62′ and connected to the optical fiber(s) 25′ of the stub cable 24′.

Each stub cable 24′ extends from the consolidation terminal 300 into the multi-port optical connection terminal 100 through a stub cable port 118 provided through an exterior wall of the multi-port terminal optical connection terminal 100. Accordingly, the present disclosure advantageously facilitates “daisy-chaining” of a plurality of connection terminals 100 and a consolidation terminal 300 together while also reducing preparation time and providing additional advantages as discussed herein. The optical fibers 25 of the stub cable 24′ within the multi-port optical connection terminal 100 may be pre-connectorized, and the optical connectors 182 are each inserted into a connector adapter 180 seated in one of the connector ports 124 provided through an exterior wall of the terminal 100. One or more pre-connectorized drop cables 16 are then interconnected with the connectorized optical fibers of the stub cable 24′ by inserting the pre-connectorized ends of the drop cables 16 (e.g the connectors thereof) into the adapters seated in the connector ports 124 from the exterior of the multi-port optical connection terminal 100. The drop cables 16 include at least one single mode or multimode optical fiber of any type optically connected to a single fiber or multi-fiber optical connector in a conventional manner. The other ends of the drop cables 16 are optically connected to respective optical fibers of the communications network within an outside plant connection terminal 28 at a delivery point, such as an outside plant network access point (NAP) closure, local convergence cabinet (LCC), terminal, pedestal or network interface device (NID). As shown, one or more stub cables 24 extends from the closure 14 to a multi-port optical connection terminal 100 positioned at a distance from the mid-span access location, such as a telephone pole, hand-hole, vault or pedestal (not shown) in the fiber optic network 10. Each drop cable 16 extends from a multi-port optical connection terminal 100 to an outside plant connection terminal 28 located at a delivery point such as a subscriber premises.

Referring now to FIGS. 3 and 4, exemplary embodiments of connection terminals 100 and various components thereof in accordance with the present disclosure are provided. As shown, a terminal 100 in accordance with the present disclosure may include a housing which may include a body 140 which may, for example, be formed from a base 152 and a cover 154. The base 152 and cover 154 may be formed from suitable materials, which may for example be lightweight and rigid. For example, suitable polymers or metals may be utilized.

Base 152 may include an exterior wall 160 which may define an interior cavity of the base 152. Further, a plurality of connector ports 124 may extend through the exterior wall 160 and provide access to the interior cavity. For example, the exterior wall 160 may include a first end wall 162. a second opposing end wall 164 which is opposite the first end wall 162 along a longitudinal axis of the terminal 100, a first sidewall 166, and a second opposing sidewall 168 which is opposite the first sidewall 166 along a lateral axis of the terminal 100. The sidewalls and end walls may, for example, generally form an outer perimeter of the base 152.

The exterior wall 160 may further include one or more angled surfaces 169, which may for example, each extend at an angle to a plane defined by the lateral and longitudinal axes of the terminal 100. In these embodiments, the connector ports 124 may be defined in the angled surfaces 169. For example, one or more connector ports 124 may be defined in each angled surface 169 as shown. Alternatively, other suitable surfaces may be provided between the sidewalls and end walls of the exterior wall 160, and the connector ports 124 may extend through one or more of these surfaces.

As illustrated. in exemplary embodiments the terminal 100 may include a plurality of connector adaptors 180. Each adaptor 180 may extend through one of the plurality of connector ports 124. The connector adaptors 180 may facilitate the connection of optical fibers from stub cable 24 or secondary stub cable 24′ to optical fibers of the drop cables 16. For example, as discussed, ends of the stub cable 24 optical fibers may be connectorized. Each such connector may be coupled to an adaptor 180 on the interior cavity side of the adaptor 180, i.e. the side of the adaptor 180 that is disposed within the interior cavity 156. Further, ends of the drop cable 16 optical fibers may be connectorized. Each such connector may be coupled to an adaptor 180 on the exterior cavity side of the adaptor 180. The adaptor 180 may thus connect the connectors and optical fibers to provide optical communication between the stub cable 24 and each drop cable 16.

The cover 154 may be connected to the base 152. Cover 154 may include an exterior wall which may define an interior cavity of the cover 154. An interior cavity 156 may thus collectively be defined between the base 152 and the cover 154 by the interior cavit(ies) of the base 152 and/or cover 154. The interior cavity 156 may, in some embodiments, generally be utilized for housing fiber optic hardware, such as adapters, optical fiber routing guides, fiber hubs, etc.

The exterior wall of the cover 154 may include a first end wall 172, a second opposing end wall 174 which is opposite the first end wall 172 along a longitudinal axis of the terminal 100, a first sidewall 176, and a second opposing sidewall (not shown) which is opposite the first sidewall 176 along a lateral axis of the terminal 100. The sidewalls and end walls may, for example, generally form an outer perimeter of the cover 154. Cover 154, such as the exterior wall thereof, may further include a bottom panel 170. The bottom panel 170 may extend between the first and second sidewalls 176, 178 along the lateral axis and between the first and second end walls 172, 170 along the longitudinal axis.

Further, a stub cable port 118 may be defined in the body 140, such as in the cover 154, and may provide access to the interior cavity 156. Stub cable 24, 24′ may extend through the stub cable port 118 and into the interior cavity 156.

Referring now to FIGS. 5 and 6, exemplary embodiments of consolidation terminals 300 and various components thereof in accordance with the present disclosure are provided. As shown, a terminal 300 in accordance with the present disclosure may include a housing which may include a body 340 which may, for example, be formed from a base 352 and a cover 354. The base 352 and cover 354 may be formed from suitable materials, which may for example be lightweight and rigid. For example, suitable polymers or metals may be utilized.

Base 352 may include an exterior wall 360 which may define an interior cavity of the base 352. Further, a plurality of connector ports 324 may extend through the exterior wall 360 and provide access to the interior cavity. For example, the exterior wall 360 may include a first end wall 362, a second opposing end wall 364 which is opposite the first end wall 362 along a longitudinal axis of the terminal 300, a first sidewall 366, and a second opposing sidewall 368 which is opposite the first sidewall 366 along a lateral axis of the terminal 300. The sidewalls and end walls may, for example, generally form an outer perimeter of the base 352.

The exterior wall 360 may further include one or more angled surfaces 369, which may for example, each extend at an angle to a plane defined by the lateral and longitudinal axes of the terminal 300. In these embodiments, the connector ports 324 may be defined in the angled surfaces 369. For example, one or more connector ports 324 may be defined in each angled surface 369 as shown. Alternatively, other suitable surfaces may be provided between the sidewalls and end walls of the exterior wall 360, and the connector ports 324 may extend through one or more of these surfaces.

As illustrated, in exemplary embodiments the terminal 300 may include a plurality of connector adaptors 380, 384. Each adaptor 380. 384 may extend through one of the plurality of connector ports 324. The connector adaptors 380 may facilitate the connection of optical fibers from stub cable 24 or secondary stub cable 24′ to optical fibers of the drop cables 16 and/or secondary stub cables 24′. For example, as discussed, ends of the stub cable 24 optical fibers may be connectorized. Each such connector 382, 386 may be coupled to an adaptor 380, 384 on the interior cavity side of the adaptor 380, 384, i.e. the side of the adaptor 380, 384 that is disposed within the interior cavity 356. Further, ends of the drop cable 16 and/or secondary stub cable 24′ optical fibers may be connectorized. Each such connector, such as connectors 54′, may be coupled to an adaptor 380, 384 on the exterior cavity side of the adaptor 380, 384. The adaptor 380, 384 may thus connect the connectors and optical fibers to provide optical communication between the stub cable 24 and each drop cable 16 and/or secondary stub cable 24′.

The cover 354 may be connected to the base 352. Cover 354 may include an exterior wall which may define an interior cavity of the cover 354. An interior cavity 356 may thus collectively be defined between the base 352 and the cover 354 by the interior cavit (ies) of the base 352 and/or cover 354. The interior cavity 356 may, in some embodiments, generally be utilized for housing fiber optic hardware, such as adapters, optical fiber routing guides, splitters 310, fiber hubs, etc.

The exterior wall of the cover 354 may include a first end wall 372, a second opposing end wall 374 which is opposite the first end wall 372 along a longitudinal axis of the terminal 300, a first sidewall 376, and a second opposing sidewall (not shown) which is opposite the first sidewall 376 along a lateral axis of the terminal 300. The sidewalls and end walls may, for example, generally form an outer perimeter of the cover 354. Cover 354, such as the exterior wall thereof, may further include a bottom panel 370. The bottom panel 370 may extend between the first and second sidewalls 376, 378 along the lateral axis and between the first and second end walls 372, 370 along the longitudinal axis.

Further, a stub cable port 318 may be defined in the body 340, such as in the cover 354, and may provide access to the interior cavity 356. Stub cable 24, 24′ may extend through the stub cable port 318 and into the interior cavity 356.

The single fiber and multi-fiber connectors optical fiber connectors as discussed herein may be any suitable commercially available single fiber or multi-fiber connectors such as, for example, SC, LC, FC, ST, SC/DC, MT-RJ, MTP and/or MPO connectors. Further, in some exemplary embodiments, the single fiber and multi-fiber adaptors as discussed herein may be ruggedized, and may thus be suitable for use in outdoor environments and exposed to various environmental conditions.

Further aspects of the invention are provided by one or more of the following embodiments:

A consolidation terminal including a body defining an interior. a stub cable port defined in the body, and a stub cable extending through the stub cable port, the stub cable including an optical fiber. The consolidation terminal further includes a splitter disposed in the interior, wherein the optical fiber is connected as an input to the splitter. The consolidation terminal includes a plurality of connector ports defined in the body, at least one single fiber connector disposed within at least one of the plurality of connector ports, the at least one single fiber connector connected to an output optical fiber from the splitter, and at least one multi-fiber connector disposed within at least one of the plurality of connector ports, the at least one multi-fiber connector connected to a plurality of output optical fibers from the splitter.

A fiber optic network including a consolidation terminal and a connection terminal. The consolidation terminal includes a body defining an interior, a stub cable port defined in the body, and a stub cable extending through the stub cable port, the stub cable including an optical fiber. The consolidation terminal further includes a splitter disposed in the interior, wherein the optical fiber is connected as an input to the splitter. The consolidation terminal further includes a plurality of connector ports defined in the body, at least one single fiber connector disposed within at least one of the plurality of connector ports, the at least one single fiber connector connected to an output optical fiber from the splitter, and at least one multi-fiber connector disposed within at least one of the plurality of connector ports, the at least one multi-fiber connector connected to a plurality of output optical fibers from the splitter. The connection terminal includes a body defining an interior, a stub cable port defined in the body. and a plurality of connector ports defined in the body. The connection terminal further includes a secondary stub cable extending through the stub cable port, the secondary stub cable including a plurality of optical fibers, wherein the secondary stub cable extends between a distal end exterior to the body and a proximal end interior to the body. The secondary stub cable includes a connector disposed at the distal end of the secondary stub cable and connected to the plurality of optical fibers of the secondary stub cable. The secondary stub cable includes a connector disposed within at least one of the plurality of connector ports, the at least one secondary connector connected to one of the plurality of optical fiber of the secondary stub cable. The connector disposed at the distal end of the secondary stub cable is connectable within a connector port of the consolidation terminal.

A consolidation terminal and/or fiber optic network of any one or more embodiments provided herein, wherein the splitter is at least a 1×8 splitter.

A consolidation terminal and/or fiber optic network of any one or more embodiments provided herein, wherein the splitter is at least a 1×32 splitter.

A consolidation terminal and/or fiber optic network of any one or more embodiments provided herein, wherein the stub cable comprises a single optical fiber.

A consolidation terminal and/or fiber optic network of any one or more embodiments provided herein, wherein the stub cable extends between a distal end exterior to the body and a proximal end interior to the body, and wherein the stub cable further comprises a connector disposed at the distal end of the stub cable and connected to the optical fiber of the stub cable.

A consolidation terminal and/or fiber optic network of any one or more embodiments provided herein, wherein the body comprises a base and a cover, wherein the stub cable port extends through the cover, and wherein the connector ports extend through the base.

A consolidation terminal and/or fiber optic network of any one or more embodiments provided herein, further comprising at least one single fiber adapter and at least one multi-fiber adapter, the at least one single fiber adapter disposed within the at least one of the plurality of connector ports in which the single fiber connector is disposed. the at least one multi-fiber adapter disposed within the at least one of the plurality of connector ports in which the multi-fiber connector is disposed.

A consolidation terminal and/or fiber optic network of any one or more embodiments provided herein, wherein an exterior wall of the body comprises a plurality of angled surfaces, and wherein the plurality of connector ports are defined in the plurality of angled surfaces.

A consolidation terminal and/or fiber optic network of any one or more embodiments provided herein, wherein each of the at least one single fiber adapter and at least one multi-fiber adapter is ruggedized.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A consolidation terminal, comprising:
a body defining an interior;
a stub cable port defined in the body;
a stub cable extending through the stub cable port, the stub cable comprising an optical fiber;
a splitter disposed in the interior, wherein the optical fiber is connected as an input to the splitter;
a plurality of connector ports defined in the body;
at least one single fiber connector disposed within at least one of the plurality of connector ports, the at least one single fiber connector connected to an output optical fiber from the splitter; and
at least one multi-fiber connector disposed within at least one of the plurality of connector ports, the at least one multi-fiber connector connected to a plurality of output optical fibers from the splitter.

2. The consolidation terminal of claim 1, wherein the splitter is at least a 1×8 splitter.

3. The consolidation terminal of claim 1, wherein the splitter is at least a 1×32 splitter.

4. The consolidation terminal of claim 1, wherein the stub cable comprises a single optical fiber.

5. The consolidation terminal of claim 1, wherein the stub cable extends between a distal end exterior to the body and a proximal end interior to the body, and wherein the stub cable further comprises a connector disposed at the distal end of the stub cable and connected to the optical fiber of the stub cable.

6. The consolidation terminal of claim 1, wherein the body comprises a base and a cover, wherein the stub cable port extends through the cover, and wherein the connector ports extend through the base.

7. The consolidation terminal of claim 1, further comprising at least one single fiber adapter and at least one multi-fiber adapter, the at least one single fiber adapter disposed within the at least one of the plurality of connector ports in which the single fiber connector is disposed, the at least one multi-fiber adapter disposed within the at least one of the plurality of connector ports in which the multi-fiber connector is disposed.

8. The consolidation terminal of claim 1, wherein an exterior wall of the body comprises a plurality of angled surfaces, and wherein the plurality of connector ports are defined in the plurality of angled surfaces.

9. The consolidation terminal of claim 7, wherein each of the at least one single fiber adapter and at least one multi-fiber adapter is ruggedized.

10. A fiber optic network, comprising:
a consolidation terminal, the consolidation terminal comprising:
a body defining an interior;
a stub cable port defined in the body;
a stub cable extending through the stub cable port, the stub cable comprising an optical fiber;
a splitter disposed in the interior, wherein the optical fiber is connected as an input to the splitter;
a plurality of connector ports defined in the body;
at least one single fiber connector disposed within at least one of the plurality of connector ports, the at least one single fiber connector connected to an output optical fiber from the splitter; and
at least one multi-fiber connector disposed within at least one of the plurality of connector ports, the at least one multi-fiber connector connected to a plurality of output optical fibers from the splitter; and
a connection terminal, the connection terminal comprising:
a body defining an interior;
a stub cable port defined in the body;
a plurality of connector ports defined in the body; and
a secondary stub cable extending through the stub cable port, the secondary stub cable comprising a plurality of optical fibers. wherein the secondary stub cable extends between a distal end exterior to the body and a proximal end interior to the body,
wherein the secondary stub cable comprises a connector disposed at the distal end of the secondary stub cable and connected to the plurality of optical fibers of the secondary stub cable; and
wherein the secondary stub cable comprises a connector disposed within at least one of the plurality of connector ports, the at least one secondary connector connected to one of the plurality of optical fiber of the secondary stub cable;
wherein the connector disposed at the distal end of the secondary stub cable is connectable within a connector port of the consolidation terminal.

11. The fiber optic terminal network of claim 10, wherein the splitter is at least a 1×8 splitter.

12. The fiber optic terminal network of claim 10, wherein the splitter is at least a 1×32 splitter.

13. The fiber optic terminal network of claim 10, wherein the stub cable comprises a single optical fiber.

14. The fiber optic terminal network of claim 10, wherein the stub cable extends between a distal end exterior to the body and a proximal end interior to the body, and wherein the stub cable further comprises a connector disposed at the distal end of the stub cable and connected to the optical fiber of the stub cable.

15. The fiber optic terminal network of claim 10, wherein the body of the consolidation terminal comprises a base and a cover, wherein the stub cable port extends through the cover, and wherein the connector ports extend through the base.

16. The fiber optic terminal network of claim 10, further comprising at least one single fiber adapter and at least one multi-fiber adapter, the at least one single fiber adapter disposed within the at least one of the plurality of connector ports in which the single fiber connector is disposed in the consolidation terminal, the at least one multi-fiber adapter disposed within the at least one of the plurality of connector ports in which the multi-fiber connector is disposed in the consolidation terminal.

17. The fiber optic terminal network of claim 10, wherein an exterior wall of the body of the consolidation terminal comprises a plurality of angled surfaces, and wherein the plurality of connector ports are defined in the plurality of angled surfaces.

18. The fiber optic terminal network of claim 16. wherein each of the at least one single fiber adapter and at least one multi-fiber adapter of the consolidation terminal is ruggedized.
